(19) United States
(12) Patent Application Publication
(10) Pub. No.: US 2009/0034746 A1
(43) Pub. Date: Feb. 5, 2009

(54) CHASSIS WITH NOISE CANCELLATION FUNCTION, NOISE CANCELLATION METHOD, METHOD FOR PRODUCING NOISE CANCELLATION SOUND DATA, PROGRAM FOR PRODUCING NOISE CANCELLATION SOUND DATA, AND MEDIUM

(76) Inventor: KOICHI NOZAKI, Tokyo (JP)

Correspondence Address: NEC CORPORATION OF AMERICA, 6535 N. STATE HWY 161, IRVING, TX, 75039, US

(21) Appl. No.: 12/184,865

(22) Filed: Aug. 1, 2008

(30) Foreign Application Priority Data
Aug. 3, 2007 (JP) 202504/2007

(51) Int. Cl. G10K 11/16

(52) U.S. Cl. 381/71.1

(57) ABSTRACT

A chassis with noise cancellation function which performs active noise cancellation in a first location for cancelling a noise generated in the chassis includes a sound receiving circuit receiving a surrounding sound in a second location, a memory circuit storing noise cancellation sound data and the surrounding sound that are associated with each other, a controller selecting the noise cancellation sound data corresponding to the surrounding sound received by the sound receiving circuit from the memory circuit and generating a noise cancellation signal based on the selected noise cancellation sound data and a sound output unit outputting a noise cancellation sound in said first location based on the noise cancellation signal to perform the active noise cancellation.

### INCORPORATION BY REFERENCE

This application is based upon and claims the benefit of priority from Japanese Patent Application No. JP 2007-202504, filed on Aug. 3, 2007, the disclosure of which is incorporated herein in its entirety by reference.

### TECHNICAL FIELD

The present invention relates to a chassis with noise cancellation function for performing active noise cancellation of the noise perceived outside the chassis mainly, a noise cancellation method, a method for producing noise cancellation sound data, a program for producing noise cancellation sound data, and a medium. In particular, the present invention relates to a chassis with noise cancellation function that outputs a noise cancellation sound based on noise cancellation sound data stored in advance, a noise cancellation method, a method for producing noise cancellation sound data, a program for producing noise cancellation sound data, and a medium.

### BACKGROUND ART

A chassis is widely used to put in various electronics. Some of the electronics includes a heat generating device such as an illuminant or a motor. A cooling fan is often provided in a chassis, which includes a heat generating device, in order to prevent a temperature from rising in the chassis. When a lot of heat is generated from the electronics, a plurality of cooling fans or a cooling fan of large size which rotates at a high speed is provided in the chassis. When the motor of the electronics, the plurality of cooling fans or the cooling fan of large size rotates at a high speed, a large noise is generated.

The chassis in which the motor of electronics or the cooling fan is put emits a noise when the motor or the cooling fan rotates.

As a technology for preventing a noise from being emitted from a chassis, a technology that puts an active noise cancellation device in a chassis is known. For example, in a related technology 1 (Japanese Patent Application Laid-Open No. 2005-133588), a projector which can perform active noise cancellation of a noise generated by a cooling fan is disclosed.

The projector according to the related art 1 calculates a fundamental frequency component and higher order frequency components of the noise by using measurement results of a rotating speed of the cooling fan and specifies a noise level for each calculated frequency. Moreover, the projector according to the related art 1 generates a sound whose phase is opposite to that of the specified noise and whose amplitude is equal to that of the specified noise. Then, the projector outputs the generated sound from a speaker.

### SUMMARY

An object of the present invention is to provide a chassis with noise cancellation function which can appropriately perform active noise cancellation of the sound perceived outside the chassis mainly without carrying out a complicated calculation, a noise cancellation method, a method for producing noise cancellation sound data, a program for producing noise cancellation sound data and a medium.

A chassis with noise cancellation function according to an exemplary object of the invention, which performs active noise cancellation in a first location for cancelling a noise generated in the chassis, includes a sound receiving circuit receiving a surrounding sound in a second location, a memory circuit storing noise cancellation sound data and the surrounding sound that are associated with each other, a controller selecting the noise cancellation sound data corresponding to the surrounding sound received by the sound receiving circuit from the memory circuit and generating a noise cancellation signal in the first location based on the selected noise cancellation sound data and a sound output unit outputting a noise cancellation sound based on the noise cancellation signal to perform the active noise cancellation.

An noise cancellation method for performing active noise cancellation in a first location of chassis with noise cancellation function according to an exemplary object of the invention includes steps of storing noise cancellation sound data and a surrounding sound that are associated with each other in a memory circuit, receiving the surrounding sound in a second location, selecting the noise cancellation sound data corresponding to the received surrounding sound from the memory circuit and generating a noise cancellation sound based on the selected noise cancellation sound data to perform the active noise cancellation for a noise generated in the chassis in the first location.

A method for producing noise cancellation sound data which specifies a noise cancellation sound for performing active noise cancellation in a first location according to an exemplary object of the invention includes steps of receiving a noise in the first location and a surrounding sound in a second location, calculating an amplitude, a frequency and a phase of the noise, generating the noise cancellation sound data including the calculated amplitude, the calculated frequency and a phase which is 180 degrees different from the calculated phase and storing the noise cancellation sound data and the surrounding sound that are associated with each other in a memory circuit.

A computer executable program for producing noise cancellation sound data according to an exemplary object of the invention includes a receiving routine for receiving a noise in the first location and a surrounding sound in a second location, a calculating routine for calculating an amplitude, a frequency and a phase of the noise, a generating routine for generating the noise cancellation sound data including the calculated amplitude and frequency, and a phase which is 180 degrees different from the calculated phase and a storing routine for storing the noise cancellation sound data and the surrounding sound that are associated with each other in a memory circuit.

A computer readable medium according to an exemplary object of the invention storing a program for producing noise cancellation sound data, the program includes a receiving routine for receiving a noise in the first location and a surrounding sound in a second location, a calculating routine for calculating an amplitude, a frequency and a phase of the noise, a generating routine for generating the noise cancellation sound data including the calculated amplitude and frequency, and a phase which is 180 degrees different from the calculated phase and a storing routine for storing the noise cancellation sound data and the surrounding sound that are associated with each other in a memory circuit.

A chassis with noise cancellation function according to an exemplary object of the invention, which performs active noise cancellation in a first location, includes sound receiving means for receiving a surrounding sound in a second location, storing means for storing noise cancellation sound data and the surrounding sound that are associated with each other, means for selecting the noise cancellation sound data corresponding to the surrounding sound received by the sound receiving means from the storing means and generating a noise cancellation signal based on the selected noise cancellation sound data and outputting means for outputting a noise cancellation sound in the first location based on the noise cancellation signal to perform the active noise cancellation.

### BRIEF DESCRIPTION OF THE DRAWINGS

Exemplary features and advantages of the present invention will become apparent from the following detailed description when taken with the accompanying drawings in which:

FIG. 1 is a front view of a chassis with noise cancellation function 100 according to a first exemplary embodiment of the present invention;

FIG. 2 is a flowchart showing an example of production of a noise cancellation sound pattern for a chassis with noise cancellation function 100 according to the first exemplary embodiment of the present invention;

FIG. 3 is an example of a table showing parameters of a noise cancellation sound pattern stored in a storage circuit 11 of a chassis with noise cancellation function 100 according to the first exemplary embodiment of the present invention;

FIG. 4 is a flowchart showing an example of operation of a chassis with noise cancellation function 100 according to the first exemplary embodiment of the present invention;

FIG. 5 is a block diagram of an active noise cancellation device 10B of a chassis with noise cancellation function 200 according to a second exemplary embodiment of the present invention;

FIG. 6 is a front view of a chassis with noise cancellation function 300 according to a third exemplary embodiment of the present invention;

FIG. 7 is a front view of a chassis with noise cancellation function 400 according to a fourth exemplary embodiment of the present invention; and

FIG. 8 is a flowchart showing an example of production of a noise cancellation sound pattern for a chassis with noise cancellation function 400 according to the fourth exemplary embodiment of the present invention.

### EXEMPLARY EMBODIMENT

Exemplary embodiments of the present invention will now be described in detail in accordance with the accompanying drawings.

### The First Exemplary Embodiment

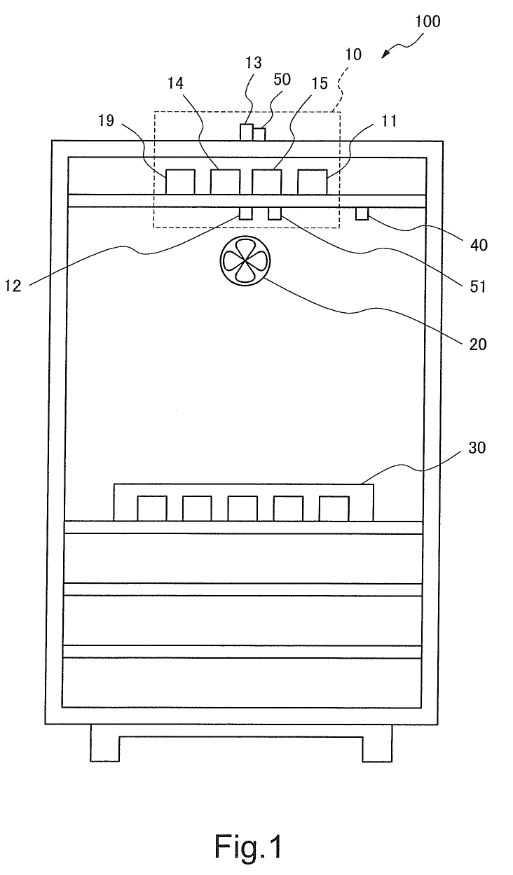

A first exemplary embodiment of a chassis with noise cancellation function according to the present invention will be described. FIG. 1 is a front view of a chassis with noise cancellation function 100 according to the exemplary embodiment of the present invention. In FIG. 1, the chassis with noise cancellation function 100 is equipped with an active noise cancellation device 10, a cooling fan 20, an electronic apparatus 30, a temperature sensor 40, a microphone 50 and a speaker 51. Then, the front surface of the chassis with noise cancellation function 100 is covered with the door not shown in FIG. 1. In the first exemplary embodiment, the chassis with noise cancellation function 100 is installed in a room in which a room temperature is kept constant.

The cooling fan 20, the electronic apparatus 30 and the temperature sensor 40 are installed in the chassis with noise cancellation function 100. In the first exemplary embodiment, the electronic apparatus 30 includes electronic components such as a CPU or a light emitting element which generates heat during operation. The temperature sensor 40 measures a temperature in the chassis with noise cancellation function 100 as an ambient temperature (hereinafter, referred to as internal chassis temperature) and transmits the measurement result to a calculation circuit 14 of the active noise cancellation device 10.

The cooling fan 20 is driven according to the measurement result of the temperature sensor 40 and has a function to lower the temperature in the chassis with noise cancellation function 100. When the internal chassis temperature measured by the temperature sensor 40 is low, the cooling fan 20 stops working or rotates at a low speed. The rotation speed of the fan increases with increase of the measured temperature. Loudness of the sound generated by the rotation of the fan is proportional to the rotation speed of the fan. A large noise such as wind roar is generated when the fan rotates at high speed.

The active noise cancellation device 10 includes the microphone 50, the speaker 51, a microphone 12, a speaker 13, a timer 19, a memory circuit 11, the calculation circuit 14 and a controller 15.

The microphone 50 and the speaker 51 are used when a noise cancellation sound pattern as mentioned below is generated. The microphone 50 is placed in a first location that is outside the chassis with noise cancellation function 100 as needed, receives a noise that is perceived around the first location, and outputs electronic signals to the calculation circuit 14 corresponding to the perceived noises. The speaker 51 is placed inside the chassis with noise cancellation function 100 as needed, and outputs a pseudo-noise for producing a noise cancellation sound pattern mentioned below.

The microphone 12 is placed in a second location that is a neighborhood of a noise source in the chassis with noise cancellation function 100 to receive a sound mainly generated by the noise source as a surrounding sound, and transmits electronic signals to the calculation circuit 14 corresponding to the received sounds. In the first exemplary embodiment, the microphone 12 is placed in a neighborhood of the cooling fan 20 to receive a sound in the chassis with noise cancellation function 100 that is mainly generated by the cooling fan 20 (hereinafter, referred to as internal chassis sound).

The speaker 13 is placed in a first location that is an area in which active noise cancellation is performed, to cancel a noise outside the chassis with noise cancellation function 100, and outputs a sound for the active noise cancellation (hereinafter, referred to as noise cancellation sound). Here, the noise cancellation sound is generated based on the noise cancellation sound pattern and is a sound for performing the active noise cancellation by that the internal chassis sound perceived outside the chassis with noise cancellation function 100 is cancelled.

The timer 19 is a time measurement circuit which measures a time during a noise cancellation control period mentioned below. The timer 19 transmits the measurement result on the noise cancellation control period to the calculation circuit 14.

In the memory circuit 11A, a plurality of noise cancellation sound data is stored. The noise cancellation sound data are information about a parameter for specifying a waveform of a noise cancellation sound. Each of the data is stored in the memory circuit 11 by being associated with the internal chassis sound and the internal chassis temperature. Hereinafter, in each exemplary embodiment, the data about a parameter for specifying a waveform of a noise cancellation sound is described as a noise cancellation sound pattern.

The calculation circuit 14 separates data about the internal chassis sound and the internal chassis temperature for each noise cancellation control period received from the timer 19. The calculation circuit 14 calculates an amplitude, a frequency and a phase for each of the separated internal chassis sound. Moreover, the calculation circuit 14 associates a calculation result with the internal chassis temperature for each noise cancellation control period and transmits them to the controller 15.

The controller 15 selects, from the memory circuit 11, the noise cancellation sound pattern corresponding to the calculation results and the internal chassis temperature received from the calculation circuit 14. The controller 15 generates a noise cancellation signal based on the selected noise cancellation sound pattern and outputs it to the speaker 13. The speaker 13 outputs a noise cancellation sound based on the noise cancellation signal. Specifically, the controller 15 sequentially reads out the noise cancellation sound pattern from the memory circuit 11, converts the pattern into an analog value by a D/A converter, and outputs the converted signal as the noise cancellation signal to the speaker 13. Further, a method for generating the selected noise cancellation signal is not limited to the method mentioned above.

By outputting the noise cancellation sound from the speaker 13, active noise cancellation is performed.

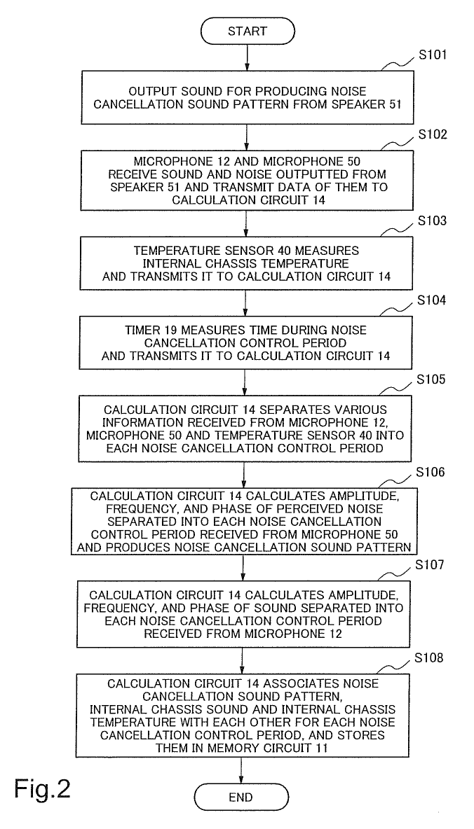

Next, an operation for storing the noise cancellation sound pattern will be described using FIG. 2. The noise cancellation sound pattern is information about the parameter for specifying the waveform of the noise cancellation sound. In the first exemplary embodiment, the noise cancellation sound pattern is information about an amplitude, a frequency and a phase for specifying the noise cancellation sound.

First, the microphone 50 is located in a neighborhood of the speaker 13 where is outside the chassis with noise cancellation function 100, and the speaker 51 is located in a neighborhood of the cooling fan 20 where is inside the chassis with noise cancellation function 100. In this state, the controller 15 makes the speaker 51 output the pseudo-noise having a predetermined frequency band corresponding to the noise pattern generated by the cooling fan 20 (S101). In the first exemplary embodiment, noise data of the pseudo-noise are stored in the memory circuit 11 in advance. The noise data are retrieved from the memory circuit 11 and output to the speaker 51 by the controller 15. Here, a frequency range of the pseudo-noise for producing a noise cancellation sound pattern that is output from the speaker 51 is set to be sufficiently wide enough to cover the frequency band of the internal chassis sound which is cancelled by performing the active noise cancellation.

The microphone 12 located inside the chassis with noise cancellation function 100 receives the pseudo-noise output from the speaker 51 as the internal chassis sound. The microphone 50 located outside the chassis with noise cancellation function 100 perceives the pseudo-noise output from the speaker 51 output from the speaker 51 in order to produce the noise cancellation sound pattern, and transmits electronic signals to the calculation circuit 14 corresponding to the perceived noise (S102). The temperature sensor 40 measures the internal chassis temperature and transmits the measurement result to the calculation circuit 14 (S103).

Moreover, the timer 19 measures a time during the noise cancellation control period and transmits the measured time to the calculation circuit 14 (S104). Here, the noise cancellation control period is a short period of time in which it can be considered that the amplitude, the frequency, and the phase of the pseudo-noise output from the speaker 51 and the internal chassis temperature are constant. Since being influenced by the environment in which the chassis with noise cancellation function 100 is located (a temperature, a state of noise generation in a surrounding area, or the like), the noise cancellation control period is appropriately determined according to the environment. In the first exemplary embodiment, the timer 19 measures the time during the noise cancellation control period based on a period in the memory circuit 11 in advance.

The calculation circuit 14 separates the signals of the perceived noise received by the microphone 50, the signals of the internal chassis sound received by the microphone 12 and the internal chassis temperature measured by the temperature sensor 40 for data for each noise cancellation control period (S105).

Moreover, the calculation circuit 14 calculates the amplitude, the frequency and the phase of the perceived noise received by the microphone 50 and separated for each noise cancellation control period. The calculation circuit 14 outputs the calculated amplitude, the calculated frequency, and the phase which is 180 (π) degrees different from the calculated phase as a noise cancellation sound pattern (S106) Here, the phase is a phase for a predetermined timing in common with the calculation circuit 14 and the controller 15. For example, the phase for a reference clock used for the calculation circuit 14 and the controller 15 can be used.

Similarly, the calculation circuit 14 calculates the amplitude, the frequency and the phase of the internal chassis sound received by the microphone 12 and separated for each noise cancellation control period (S107).

After that, the calculation circuit 14 associates the produced noise cancellation sound pattern (an amplitude, a frequency and a phase), the internal chassis sound (an amplitude, a frequency and a phase), and the internal chassis temperature with each noise cancellation control period, respectively. The associated data above mentioned are stored in the memory circuit 11 (S108).

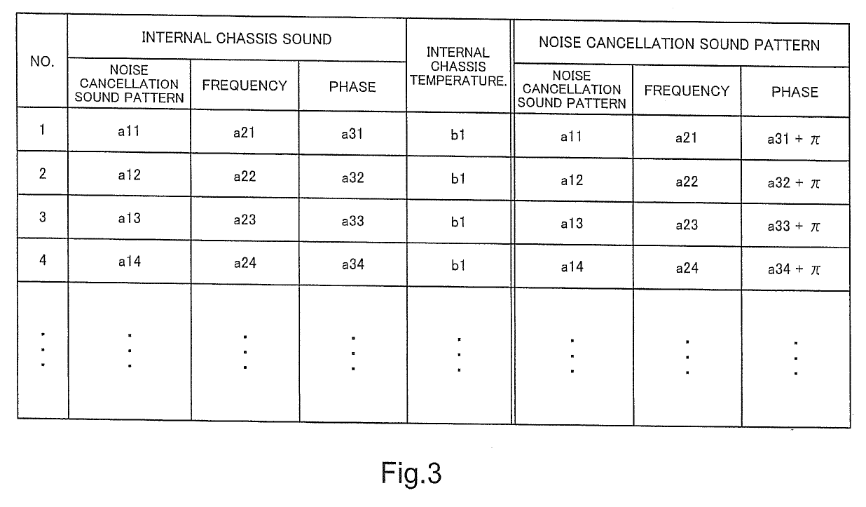

FIG. 3 shows an example of data with respect to a noise cancellation sound pattern (data), an internal chassis sound and an internal chassis temperature stored in the memory circuit 11.

As mentioned above, in the first exemplary embodiment, the noise cancellation sound pattern is information of the parameters for specifying a waveform of the sound whose amplitude and frequency are the same as that of the perceived noise received by the microphone 50, and whose phase differs by 180 degrees from that of. The perceived noise is a sound perceived around the speaker 13 corresponding to outputting the pseudo-noise from the speaker 51. Accordingly, when the speaker 13 outputs the noise cancellation sound generated based on the noise cancellation sound pattern, the perceived noise and the noise cancellation sound are synthesized and the perceived noise is cancelled.

Further, the noise cancellation sound pattern calculated in the calculation circuit 14 can be made the same amplitude, frequency and phase as that of the perceived noise perceived by the microphone 50. In this case, the speaker 13 outputs the sound whose phase is shifted 180 degrees from a phase of the noise cancellation sound generated based on the noise cancellation sound pattern. A method can be applied in which the controller 15 reads out data of the noise cancellation sound pattern and generates the noise cancellation sound by shifting a phase by 180 degrees, and the speaker 13 outputs the generated noise cancellation sound.

Here, the microphone 50 and the speaker 51 are only required when the noise cancellation sound pattern is produced. Once the noise cancellation sound pattern is produced, the microphone 50 and the speaker 51 are not required after that. Accordingly, the microphone 50 and the speaker 51 can be installed only when the noise cancellation sound pattern is produced, that is, when evaluation or manufacturing of the chassis with noise cancellation function 100 is performed. Thus the chassis with noise cancellation function 100 without the microphone 50 and the speaker 51 can be shipped.

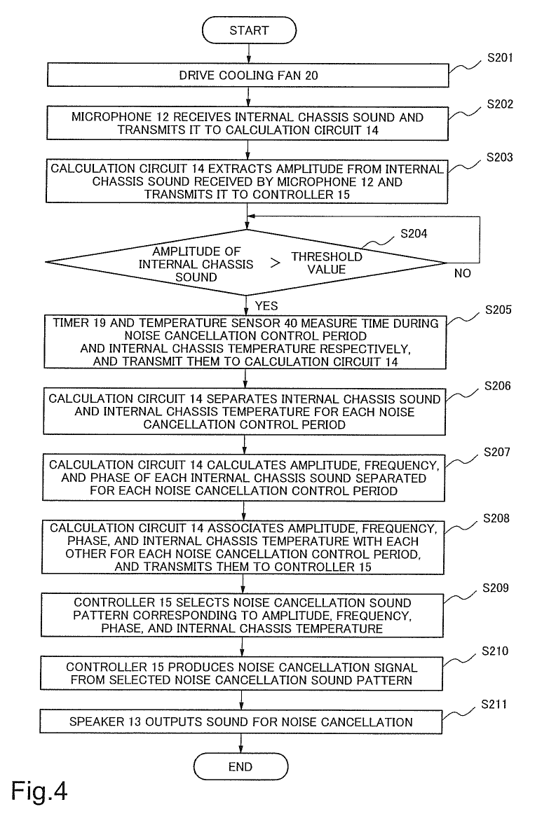

Next, a procedure in which the active noise cancellation is performed by using the noise cancellation sound pattern stored in the memory circuit 11, that is outputting the noise cancellation sound, will be described using FIG. 4. In the first exemplary embodiment, the controller 15 of the active noise cancellation device 10 constantly monitors an amount of an amplitude of the internal chassis sound received by the microphone 12.

First, when the temperature sensor 40 detects an increase of the internal chassis temperature, the cooling fan 20 begins rotating (S201). A noise which is generated by the cooling fan 20 is received by the microphone 12 as the internal chassis sound. An output of the microphone 12 is transmitted to the calculation circuit 14 (S202). The calculation circuit 14 extracts an amplitude of the internal chassis sound from the output and transmits the amplitude to the controller 15 (S203). When the amplitude of the internal chassis sound transmitted from the calculation circuit 14 is larger than a predetermined threshold value (“YES” in S204), the controller 15 makes the temperature sensor 40 and the timer 19 transmit information about the internal chassis temperature and the noise cancellation control period to the calculation circuit 14 (S205). Moreover, the controller 15 makes the calculation circuit 14 start separating the internal chassis sound and the internal chassis temperature for each noise cancellation control period (S206).

Moreover, the calculation circuit 14 calculates an amplitude, a frequency and a phase with respect to each separated internal chassis sound (S207), associates the calculation results with the internal chassis temperature in the same noise cancellation control period and transmits the calculation results to the controller 15 (S208). The controller 15 selects the noise cancellation sound pattern corresponding to the received calculation result and internal chassis temperature from the memory circuit 11 (S209).

The controller 15 generates the noise cancellation signal based on the selected noise cancellation sound pattern (S210) and outputs it to the speaker 13. Then, the speaker 13 outputs the noise cancellation sound based on the noise cancellation signal (S211).

By outputting the noise cancellation sound from the speaker 13, active noise cancellation of the sound perceived around the speaker 13 is performed. After that, the controller 15 repeats a series of processes for each noise cancellation control period, which includes selecting the noise cancellation sound pattern based on the internal chassis sound and the internal chassis temperature, generating the noise cancellation sound based on the selected noise cancellation sound pattern and performing the active noise cancellation.

Further, in S204, when a level of the internal chassis sound measured by the microphone 12 is lower than a predetermined level (“NO” in S204), the controller 15 stops transmitting the data of the internal chassis temperature and the noise cancellation control period to the calculation circuit 14, and ends the active noise cancellation.

As mentioned above, the active noise cancellation device 10 of the chassis with noise cancellation function 100 according to the first exemplary embodiment associates the internal chassis sound, the internal chassis temperature and the noise cancellation sound pattern mutually and stores them in the memory circuit 11 in advance. When performing active noise cancellation, the microphone 12 receives the internal chassis sound in a second location, that is, in a neighborhood of a noise source. Moreover, the temperature sensor 40 measures the internal chassis temperature in the second location. The controller 15 selects the noise cancellation sound pattern corresponding to the received internal chassis sound and the measured internal chassis temperature from the memory circuit 11, generates the noise cancellation signal based on the selected noise cancellation sound pattern and outputs the noise cancellation signal to the speaker 13. By outputting the noise cancellation sound from the speaker 13, active noise cancellation of the noise perceived around the speaker 13, that is, in a first location where active noise cancellation is performed, is performed.

Since the noise cancellation sound pattern is stored in the memory circuit 11 in advance, the controller 15 can easily select the most suitable noise cancellation sound pattern based on the received internal chassis sound and the measured internal chassis temperature and output the noise cancellation signal. Accordingly, the active noise cancellation device 10 of the chassis with noise cancellation function 100 according to the first exemplary embodiment can appropriately perform active noise cancellation of the noise perceived around the speaker 13, that is, in the first location where the active noise cancellation is performed, without carrying out a complicated calculation.

Here, by installing the microphone 12 and the temperature sensor 40 near the cooling fan 20, that is, in the second location that is near a noise source, a change in noise generated by the noise source can be perceived sensitively. Moreover, by arranging the speaker 13 in the first location, that is, in an area where the active noise cancellation has to be performed, the active noise cancellation can be performed more directly.

Moreover, in the first exemplary embodiment, the active noise cancellation device 10 performs the active noise cancellation for each noise cancellation control period. By performing various calculations and generating the noise cancellation sound for each noise cancellation control period, the active noise cancellation device 10 can reduce a load on the calculation circuit 14 and the controller 15. Since the noise cancellation control period is set to be a very short period in which the internal chassis sound and the internal chassis temperature can be regarded as being constant, even when the internal chassis sound changes in a short period of time, the active noise cancellation device 10 can follow the change in real time and perform the active noise cancellation effectively.

Accordingly, the active noise cancellation device 10 of the chassis with noise cancellation function 100 according to the first exemplary embodiment can steadily perform the active noise cancellation with low load.

Here, even when the noise cancellation control period is set to be a sufficiently short period, either the internal chassis sound or the internal chassis temperature during a certain noise cancellation control period (T1) may differ from those during a next noise cancellation control period (T2). Accordingly, the calculation circuit 14 may estimate measurement data during a noise cancellation control period (T3) that is a next period of T2 based on measurement data of the period T1 and measurement data of the period T2, and the controller 15 may generate the noise cancellation signal during the period T3 based on the estimated result.

For example, the calculation circuit 14 calculates a change rate of the measurement data during the period T1 to the measurement data during the period T2 and estimates the measurement data during the period T3. The controller 15 selects the noise cancellation sound pattern based on the estimated data, and the controller 15 generates the noise cancellation signal based on the noise cancellation sound pattern during the period T3.

Thus, the active noise cancellation device 10 does not perform noise cancellation during the period T2 based on the measurement data during the period T1. The calculation circuit 14 estimates the measurement data during the period T2 and generates the noise cancellation sound based on the estimated value. Thereby, the active noise cancellation device 10 can perform the active noise cancellation more correctly. Moreover, the calculation circuit 14 may calculate a change rate of the measurement data during the period T1 to the measurement data during the period T3 and estimate measurement data during a noise cancellation control period (T4) that is a next period of T3.

It is not necessary to keep a length of the noise cancellation control period constant. For example, in order not to generate a discontinuous point on a waveform of the noise cancellation sound, the length of the noise cancellation control period can be made variable so that the length is a natural number multiple of a period of a waveform in the noise cancellation sound pattern. Further, although above mentioned multiple number is preferably small and “1” is ideal, the calculation circuit 14 has to calculate an amplitude, a frequency and a phase at high speed with respect to the internal chassis sound when applying the smaller multiple number. Therefore, a multiple number may be determined according to a trade-off between a required precision of active noise cancellation and a processing capacity required for the calculation.

In the first exemplary embodiment, the noise cancellation sound pattern is associated with not only the internal chassis sound but also the internal chassis temperature. This is since sound velocity is dependent on an ambient temperature. In the first exemplary embodiment, the microphone 50 is installed outside the chassis with noise cancellation function 100, more specifically, in the room in which a temperature is constant mostly. On the other hand, the microphone 12 is installed inside the chassis with noise cancellation function 100, where a temperature changes greatly.

A speed of sound inside the chassis with noise cancellation function 100 differs from that of outside the chassis with noise cancellation function 100 since the temperature outside the chassis and the temperature inside the chassis are different from each other. Therefore, even when the same sound is generated in the chassis, the speed of the sound around the speaker 13 varies with variation of the internal chassis temperature. Accordingly, even when the internal chassis temperature varies greatly, the controller 15 can accurately perform active noise cancellation of a sound perceived around the speaker 13 by selecting a noise cancellation sound pattern corresponding to the internal chassis temperature.

Here, “frequency-output” characteristic information on the microphone 12 and the speaker 13 is stored in the memory circuit 11, and the calculation circuit 14 corrects waveforms of the internal chassis sound and the noise cancellation sound pattern by using the characteristic information at the time of calculation. Accordingly, the active noise cancellation device 10 can perform the active noise cancellation accurately. In this case, when a failure of the microphone 12 or the speaker 13 occurs, if the “frequency-output” characteristic information on the replaced microphone 12 or speaker 13 is stored again, a user can use the active noise cancellation device 10 without any change.

In the first exemplary embodiment, when the noise cancellation sound pattern is produced, the speaker 51 outputs the pseudo-noise with a predetermined band for producing the noise cancellation sound pattern. Even when a plurality of sources that generate internal chassis sound are arranged inside the chassis with noise cancellation function 100, the active noise cancellation device 10 can produce noise cancellation sound patterns corresponding to a variety of situations by outputting pseudo-noises with various frequencies from the speaker 51. On the other hand, when only one source generates the noise (for example, only the cooling fan 20), as follows can be done instead of outputting the pseudo-noise from the speaker 51. A sound instead of the pseudo-noise for producing a noise cancellation sound pattern is output by actually driving the noise source, for example the cooling fan 20. The microphone 50 and the microphone 12 receive the sound generated by the cooling fan 20, and a noise cancellation sound pattern is produced based on the sound perceived by the microphone 50.

In the first exemplary embodiment, in order to specify the parameters of the internal chassis sound, three parameters, that is, an amplitude, a frequency and a phase are used. However, when the noise source generating the sound is only the cooling fan 20, the controller 15 may specify a rotating speed of the cooling fan 20 using only one of either the amplitude or the frequency of the sound and may select the noise cancellation sound pattern based on the rotating speed. This is since the sound generated by the cooling fan 20 is determined by the rotating speed. Therefore, the rotating speed can be specified by obtaining only the amplitude or the frequency and if the rotating speed can be specified, the state of the internal chassis sound can also be specified. The controller 15 may detect the rotating speed of the cooling fan 20 directly and may select the noise cancellation sound pattern based on the detected rotating speed of the fan.

### Second Exemplary Embodiment

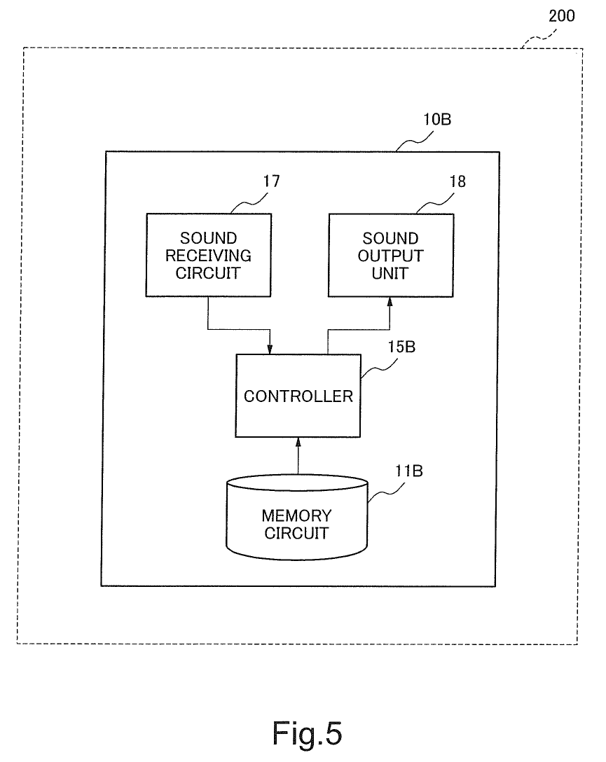

In the first exemplary embodiment, when a noise cancellation sound pattern is selected, an internal chassis temperature is used in addition to an internal chassis sound. However, when a change in an internal chassis temperature of a chassis with noise cancellation function 200 is small or when a change in a phase of the noise cancellation sound by the change in the internal chassis temperature can be negligible, it is not necessary to use the internal chassis temperature for the selection of the noise cancellation sound pattern. In the case, the temperature sensor is not required. FIG. 5 shows the chassis with noise cancellation function 200 according to a second exemplary embodiment and a block diagram of the active noise cancellation device 10B provided in the chassis with noise cancellation function 200. Since the chassis with noise cancellation function 200 is nearly the same as the chassis with noise cancellation function 100 of the first exemplary embodiment, the chassis with noise cancellation function 200 is indicated by a dotted line in FIG. 5. In FIG. 5, the active noise cancellation device 10B provided in the chassis with noise cancellation function 200 includes a sound receiving circuit 17, a sound output unit 18, a memory circuit 11B and a controller 15B.

The sound receiving circuit 17 receives the internal chassis sound and calculates the amplitude, the frequency and the phase with respect to the received internal chassis sound. Then, the sound receiving circuit 17 transmits the calculation results to the controller 15B.

A plurality of noise cancellation sound patterns corresponding to the internal chassis sound received by the sound receiving circuit 17 is stored in the memory circuit 11B. In the second exemplary embodiment, the noise cancellation sound pattern is information of the parameters for producing a waveform of the sound whose amplitude and frequency are the same as that of the sound which is received around the sound output unit 18 as a perceived noise, and whose phase differs by 180 degrees from that of the perceived noise.

The controller 15B selects the noise cancellation sound pattern corresponding to the calculation result received from the sound receiving circuit 17 from the memory circuit 11B and generates the noise cancellation signal to output to the sound output unit 18.

Then, the sound output unit 18 outputs the noise cancellation sound based on the noise cancellation signal, and the noise perceived around the sound output unit 18 is cancelled by active noise cancellation.

As mentioned above, the active noise cancellation device 10B provided in the chassis with noise cancellation function 200 stores the noise cancellation sound pattern in the memory circuit 11B in advance. When the controller 15B generates the noise cancellation signal based on the noise cancellation sound pattern selected from the memory circuit 11B, and the sound output unit 18 outputs the noise cancellation sound based on the noise cancellation signal, the noise which is received around the sound output unit 18 can be accurately cancelled by active noise cancellation. Accordingly, the active noise cancellation device 10B of the chassis with noise cancellation function 200 according to the second exemplary embodiment can accurately cancel the noise perceived around the sound output unit 18 by active noise cancellation without carrying out a complicated calculation.

### Third Exemplary Embodiment

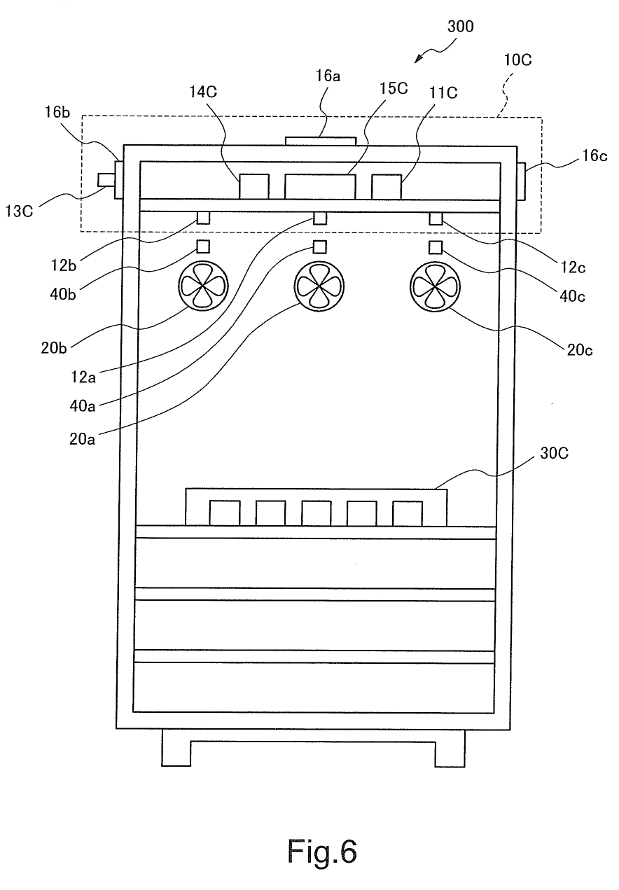

A third exemplary embodiment of a chassis with noise cancellation function will be described. FIG. 6 shows a schematic configuration of a chassis with noise cancellation function 300 according to the third exemplary embodiment. In FIG. 6, the chassis with noise cancellation function 300 includes an active noise cancellation device 10C, three cooling fans 20a to 20c, an electronic apparatus 30C and three temperature sensors 40a to 40c. Then, the front surface of the chassis with noise cancellation function 300 is covered with the door not shown in FIG. 6.

The electronic apparatus 30C includes an electronic component such as a CPU or a light emitting element which generates heat during operation. The temperature sensors 40a to 40c are installed near the cooling fans 20a to 20c respectively. The temperature sensors 40a to 40c measure the internal chassis temperature and transmit the measured internal chassis temperatures to the calculation circuit 14C of the active noise cancellation device 10C. The cooling fans 20a to 20c are installed inside the chassis with noise cancellation function 300 to cool inside of the chassis with noise cancellation function 300. The cooling fans 20a to 20c are driven according to measurement results of the temperature sensors 40a to 40c.

The active noise cancellation device 10C includes three microphones 12a to 12c, a speaker 13C, three speaker installation stands 16a to 16c, a memory circuit 11C, a calculation circuit 14C and a controller 15C. In the third exemplary embodiment, the microphones 12a to 12c are installed near the cooling fans 20a to 20c to receive the internal chassis sound, respectively.

The speaker installation stands 16a to 16c are used for installing the speaker 13C, and are fixed on an upper surface, a left surface and a right surface of the outside of the chassis with noise cancellation function 300, respectively. The speaker 13C is installed on the installation stand selected among the speaker installation stands 16a to 16c based on the positional relationship between an area in which a noise is cancelled and the chassis with noise cancellation function 300. In the third exemplary embodiment, when the chassis with noise cancellation function 300 is installed beside a side wall on the observer's right, the speaker 13C is installed on the speaker installation stand 16b that is provided on a left side surface of the chassis with noise cancellation function 300. The speaker installation stand 16b detects installation of the speaker 13C and transmits location information of the speaker 13C to the controller 15C.

The memory circuit 11C stores three sets of noise cancellation sound patterns corresponding to each of the speaker installation stands 16a to 16c (hereinafter, described as noise cancellation sound pattern groups a to c). Here, in the third exemplary embodiment, the microphones 12a to 12c and the temperature sensors 40a to 40c are associated with the closest speaker installation stands 16a to 16c respectively. The noise cancellation sound pattern groups a to c include a plurality of noise cancellation sound patterns which are associated with the internal chassis sounds received by the microphones 12a to 12c and the internal chassis temperatures measured by the temperature sensors 40a to 40c.

For example, the noise cancellation sound pattern group b corresponding to the speaker installation stand 16b includes a plurality of noise cancellation sound patterns which are associated with the internal chassis sound received by the microphone 12b and the internal chassis temperature measured by the temperature sensor 40b. When the speaker 13C is installed on the speaker installation stand 16b, the controller 15C selects the most suitable noise cancellation sound pattern among the noise cancellation sound pattern group b.

Since a main function of the calculation circuit 14C and the controller 15C is almost the same as the calculation circuit 14 and the controller 15 of the chassis with noise cancellation function 100 of the first exemplary embodiment, the detailed description will be omitted.

Next, a series of operations of the active noise cancellation device 10C of the chassis with noise cancellation function 300 in the third exemplary embodiment will be described. In the third exemplary embodiment, when a user installs the speaker 13C on the speaker installation stand 16b, the speaker installation stand 16b detects installation of the speaker 13C and transmits location information on the speaker 13C to the controller 15C. The controller 15C recognizes that the speaker 13C is installed on the speaker installation stand 16b, and starts to monitor an amount of the amplitude of the internal chassis sound received by the microphone 12b that is associated with the speaker installation stand 16b.

Here, when an internal chassis temperature increases due to driving of the electronic apparatus 30C, the temperature sensors 40a to 40c detect the increase. When the temperature sensors 40a to 40c detect the increase of the internal chassis temperature, the cooling fans 20a to 20c are driven.

When the amplitude of the internal chassis sound received by the microphone 12b becomes larger than the predetermined threshold value, the controller 15C controls the calculation circuit 14C to start calculation of the internal chassis sound received by the microphone 12b. Moreover, the controller 15C controls the temperature sensor 40b to transmit the internal chassis temperature measured by the temperature sensor 40b to the calculation circuit 14C.

The calculation circuit 14C separates the internal chassis sound received from the microphone 12b and the internal chassis temperature received from the temperature sensor 40b for each noise cancellation control period. In the third exemplary embodiment, the calculation circuit 14C includes a reference clock and separates the internal chassis sound and the internal chassis temperature for each noise cancellation control period with the reference clock. Moreover, the calculation circuit 14C calculates the amplitude, the frequency and the phase of the internal chassis sound separated for each noise cancellation control period.

After that, the calculation circuit 14C associates the amplitude, the frequency and the phase which are obtained by the calculation with the internal chassis temperature for each noise cancellation control period, and transmits an associated result to the controller 15C.

The controller 15C selects the noise cancellation sound pattern corresponding to the associated result received from the calculation circuit 14C from the noise cancellation sound pattern group b stored in the memory circuit 11C. Moreover, the controller 15C generates the noise cancellation signal based on the noise cancellation sound pattern selected from the noise cancellation sound pattern group b and outputs the noise cancellation signal to the speaker 13C. Then, the noise cancellation sound is output from the speaker 13C, and the noise perceived around the speaker 13C (that is, around the speaker installation stand 16b) is cancelled by the active noise cancellation.

As mentioned above, in the chassis with noise cancellation function 300 according to the third exemplary embodiment, the plurality of speaker installation stands 16a to 16c are installed and the installation location of the speaker 13C can be selected according to the installation location of the chassis with noise cancellation function 300, the location where a user wants to perform active noise cancellation and the like. Accordingly, the active noise cancellation device 10C of the chassis with noise cancellation function 300 can perform active noise cancellation according to an operating environment.

Moreover, when measuring points of the internal chassis sound and the internal chassis temperature is increased by additionally installing a plurality of microphones and temperature sensors, the active noise cancellation device 10C of the chassis with noise cancellation function 300 can see distributions of the internal chassis sound and the internal chassis temperature in detail. Accordingly, the active noise cancellation device 10C of the chassis with noise cancellation function 300 can more precisely perform the active noise cancellation.

Here, the memory circuit 11C of the chassis with noise cancellation function 300 stores three sets of noise cancellation sound pattern groups a to c corresponding to the speaker installation stands 16a to 16c. Accordingly, even when a plurality of microphones and temperature sensors are installed, if the noise cancellation sound pattern corresponding to the internal chassis sound and the internal chassis temperature is selected from the noise cancellation sound pattern groups a to c, active noise cancellation in a predetermined location can be performed accurately. Accordingly, the active noise cancellation device 10C of the chassis with noise cancellation function 300 can accurately perform the active noise cancellation in the predetermined location without carrying out complicated calculation.

In the third exemplary embodiment, the controller 15C selects the noise cancellation sound pattern by using the information from one microphone and one temperature sensor corresponding to the speaker stand on which the speaker 13C is installed. However, it is not limited to this method. For example, the method can be used in which the controller 15C selects one noise cancellation sound pattern by using three microphones 12a to 12c and three temperature sensors 40a to 40c and generates the noise cancellation signal.

Moreover, in the third exemplary embodiment, one speaker 13C is used for outputting the noise cancellation sound. But, a plurality of speakers can be used. By installing a plurality of speakers according to the installation location and the installation direction of the chassis with noise cancellation function 300, the active noise cancellation device 10C of the chassis with noise cancellation function 300 can more appropriately perform the active noise cancellation in the predetermined location.

### Fourth Exemplary Embodiment

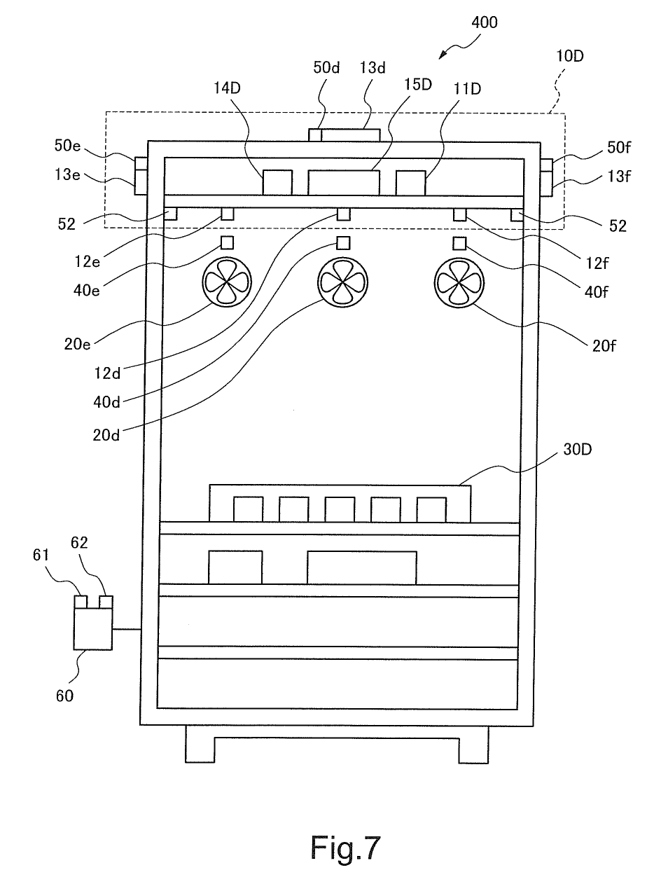

A fourth exemplary embodiment of a chassis with noise cancellation function will be described. A chassis with noise cancellation function 400 according to the fourth exemplary embodiment is characterized by having a function for producing a noise cancellation sound pattern. FIG. 7 shows a schematic configuration of the chassis with noise cancellation function 400 according to the fourth exemplary embodiment.

In FIG. 7, the chassis with noise cancellation function 400 includes an active noise cancellation device 10D, three cooling fans 20d to 20f, an electronic apparatus 30D, three temperature sensors 40d to 40f and a maintenance terminal 60.

The cooling fans 20d to 20f, the electronic apparatus 30D, the temperature sensors 40d to 40f and a heater 52 are installed inside the chassis with noise cancellation function 400. In the fourth exemplary embodiment, the electronic apparatus 30D includes an electronic component such as a CPU or a light emitting element which generates heat during operations. The temperature sensors 40d to 40f are installed near the cooling fans 20d to 20f to measure the internal chassis temperature respectively, and transmits the measured internal chassis temperature to the calculation circuit 14D of the active noise cancellation device 10D. The cooling fans 20d to 20f are driven according to the measurement result of the temperature sensors 40d to 40f respectively, and have a function to lower the internal chassis temperature.

The maintenance terminal 60 is a terminal such as a personal computer or the like which a user uses in order to maintain and monitor the electronic apparatus 30D and the active noise cancellation device 10D installed in the chassis with noise cancellation function 400. In the fourth exemplary embodiment, the maintenance terminal 60 includes a buzzer 61 and a lamp 62. The maintenance terminal 60 monitors whether or not the internal chassis sound, the internal chassis temperature and the like are normal. If various data are not output, data values do not vary, or the internal chassis sound or the internal chassis temperature exceed a prescribed value, it is judged that the active noise cancellation device 10D, the cooling fan 20 or the like fails. When the buzzer 61 is rung and the lamp 62 is lighted, a user is notified of occurrence of an abnormal condition. In the chassis with noise cancellation function 400 according to the fourth exemplary embodiment, the maintenance terminal 60 monitors various data and can report a failure immediately when the active noise cancellation device 10D, the cooling fan 20 or the like fails.

The active noise cancellation device 10D includes three microphones 50d to 50f, two heaters 52, three microphones 12d to 12f, three speakers 13d to 13f, a memory circuit 11D, the calculation circuit 14D and a controller 15D.

The microphones 50d to 50f are installed near the speaker 13d to 13f where are outside the chassis with noise cancellation function 400, and perceives a noise around the speakers 13d to 13f as a perceived noise when the noise cancellation sound pattern is produced.

Two heaters 52, which are installed inside the chassis with noise cancellation function 400, generate heat by executing a noise cancellation sound pattern producing program. In the fourth exemplary embodiment, the heater 52 includes a resistance and a value of the resistance is controlled so that the internal chassis temperature in a predetermined period is kept at a predetermined temperature by the execution of the noise cancellation sound pattern producing program.

Here, the noise cancellation sound pattern producing program causes the chassis with noise cancellation function 400 to carry out an operation for producing the noise cancellation sound pattern. According to this program, the chassis with noise cancellation function 400 produces the noise cancellation sound pattern enough to cover a frequency band of the internal chassis sound which performs active noise cancellation. In the fourth exemplary embodiment, the noise cancellation sound pattern producing program is stored in the memory circuit 11D in advance.

However, the noise cancellation sound pattern producing program may be downloaded in the controller 15D from a CD-ROM or the like when the noise cancellation sound pattern is produced. Moreover, production of the noise cancellation sound pattern can be performed by the maintenance terminal 60 instead of the controller 15D of the active noise cancellation device 10D.

Since each function of the microphones 12d to 12f, the speakers 13d to 13f, the memory circuit 11D, the calculation circuit 14D and the controller 15D is almost the same as that of the microphone 12, the speaker 13, the memory circuit 11, the calculation circuit 14 and the controller 15 of the active noise cancellation device 10 of the first exemplary embodiment, the detailed description will be omitted.

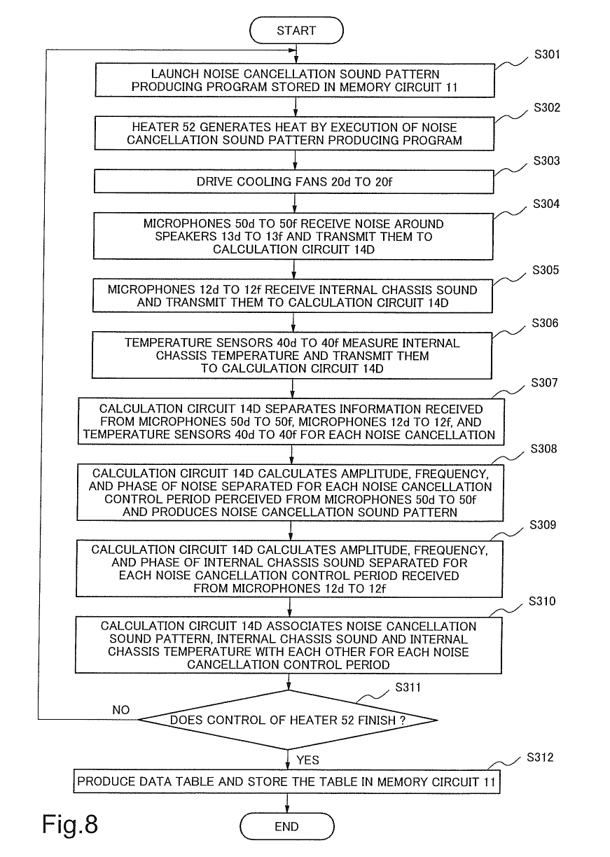

Next, a function for producing the noise cancellation sound pattern of the fourth exemplary embodiment will be described using FIG. 8.

When a user performs an input operation to activate the function for producing the noise cancellation sound pattern, the controller 15D detects the input and launches the noise cancellation sound pattern producing program stored in the memory circuit 11D (S301). The heater 52 generates heat due to execution of the noise cancellation sound pattern producing program (S302).

Since the heater 52 generates heat, temperature in the chassis with noise cancellation function 400 increases. When increase of the internal chassis temperature is measured by the temperature sensors 40d to 40f, the cooling fans 20d to 20f are driven (S303). When fans of the cooling fans 20d to 20f rotate, a sound is generated.

On the other hand, the microphones 50d to 50f installed on an upper surface, a left side surface and a right side surface of the chassis with noise cancellation function 400 perceive the noise around the speakers 13d to 13f as the perceived noise by the execution of the noise cancellation sound pattern producing program, and output signals to the calculation circuit 14D corresponding to the perceived noise (S304). The microphones 12d to 12f installed inside the chassis with noise cancellation function 400 receive the internal chassis sound, and output signals to the calculation circuit 14D corresponding to the internal chassis sound (S305). Moreover, the temperature sensors 40d to 40f transmit the measured internal chassis temperature to the calculation circuit 14D (S306).

The calculation circuit 14D separates the perceived noises perceived by the microphones 50d to 50f, the internal chassis sounds received by the microphones 12d to 12f and the internal chassis temperatures measured by the temperature sensors 40d to 40f for each noise cancellation control period (S307). The noise cancellation control period is equal to that of the first exemplary embodiment. That is, it is a short period during which the amplitude, the frequency and the phase of the perceived noises and the internal chassis sound, and the internal chassis temperatures can be considered almost constant.

Moreover, the calculation circuit 14D calculates the amplitude, the frequency and the phase with respect to each perceived noise which is perceived by the microphones 50d to 50f and separated for each noise cancellation control period. After that, the calculation circuit 14D calculates a parameter whose amplitude and frequency are equal to the calculated amplitude and frequency and whose phase is 180 degrees different from the calculated phase for each of the microphones 50d to 50f and obtains three noise cancellation sound patterns d to f (S308).

Moreover, the calculation circuit 14D calculates the amplitude, the frequency and the phase with respect to each of the internal chassis sounds which are received by the microphones 12d to 12f and separated for each noise cancellation control period (S309).

The calculation circuit 14D associates the internal chassis sounds received by the microphones 12d to 12f, the internal chassis temperatures measured by the temperature sensors 40d to 40f and the noise cancellation sound patterns d to f obtained from the perceived sounds received by the microphones 50d to 50f with each other for each noise cancellation control period (S310).

The calculation circuit 14D repeats the processes from S302 to S311, until a control of the heater 52 based on the noise cancellation sound pattern producing program finishes (S311).

When the control of the heater 52 is ended, the calculation circuit 14D associates three sets of internal chassis sounds, three sets of internal chassis temperatures and three sets of noise cancellation sound patterns d to f each other, and stores the associated result in the memory circuit 11D as a data table (S312).

As mentioned above, three noise cancellation sound patterns d to f corresponding to each of the microphones 50d to 50f are associated with the internal chassis sound and the internal chassis temperature. The three noise cancellation sound patterns d to f are stored in the data table. The three noise cancellation sound patterns d to f are associated with each of the speakers 13d to 13f. Performing the active noise cancellation, the controller 15D generates the noise cancellation signals based on the corresponding noise cancellation sound patterns d to f. The speakers 13d to 13f output the noise cancellation sounds based on the corresponding noise cancellation signals.

When the temperature sensors 40d to 40f detect increase of the internal chassis temperature, the cooling fans 20d to 20f are driven. When the amplitude of the internal chassis sounds received by the microphones 12d to 12f becomes larger than a predetermined threshold value, the controller 15D start to perform the active noise cancellation.

The controller 15D selects noise cancellation sound patterns d to f corresponding to the amplitude, the frequency, and the phase of three internal chassis sounds received by the microphones 12d to 12f and corresponding to three internal chassis temperatures measured by the temperature sensors 40d to 40f from the data table stored in the memory circuit 11D.

The controller 15D generates three noise cancellation signals based on the selected noise cancellation sound patterns d to f, and outputs them to the corresponding speakers 13d to 13f. The corresponding speakers 13d to 13f output three noise cancellation sounds. When the three noise cancellation sounds are output from the speakers 13d to 13f, the noise leaking from the chassis with noise cancellation function 400 can be accurately cancelled by the active noise cancellation.

Here, in the fourth exemplary embodiment, since it is assumed that the internal chassis temperature increases by driving the electronic apparatus 30D, an amount of heat generated by the heater 52 is varied by execution of the noise cancellation sound pattern producing program. However, when it is likely that the internal chassis temperature is lower than the temperature of the place where the chassis with noise cancellation function 400 is installed due to installation of a heat absorption material or the like, it is preferable to produce the noise cancellation sound pattern, which is obtained by installing the cooler in the active noise cancellation device 10D and controlling the cooler to reduce the internal chassis temperature when executing a noise cancellation sound pattern producing program.

By the way, unexpected data may be obtained with respect to the internal chassis sound and the internal chassis temperature caused by change of the external environment of the chassis with noise cancellation function 400, aging of a noise generation place of the cooling fans 20d to 20f or the like. In such case, the noise cancellation sound pattern corresponding to the internal chassis sound and the internal chassis temperature is not stored in the memory circuit 11D. In order to avoid such case, “noise cancellation sound pattern learning function” which adds a new noise cancellation sound pattern at any time by using the function for producing a noise cancellation sound pattern as mentioned above can be realized. Next, an example of a method for realizing such “noise cancellation sound pattern learning function” is described below.

First, the controller 15D selects the noise cancellation sound pattern. At that time, when a required noise cancellation sound pattern is not stored in the memory circuit 11D, the controller 15D stops outputting the noise cancellation signal. The controller 15D receives the perceived noises using the microphones 50d to 50f. The controller 15D produces the noise cancellation sound pattern whose amplitude and frequency are equal to those of the perceived noises and whose phase are 180 degrees different from those of the perceived noises. Then, the controller 15D associates the noise cancellation sound pattern with the received internal chassis sound and the measured internal chassis temperature, and stores the associated result in the memory circuit 11D.

Thereby, since the internal chassis sound and the internal chassis temperature are updated at any time, the chassis with noise cancellation function 400 can also continue the sound cancelling operation even in the environment in which the internal chassis sound and the internal chassis temperature which are not produced in advance are received and measured.

As mentioned above, in the fourth exemplary embodiment, since the active noise cancellation device 10D of the chassis with noise cancellation function 400 includes a function for producing noise cancellation sound pattern, when a new cooling fan is installed in the chassis with noise cancellation function 400 or when the microphone 12, the speaker 13 or the like of the active noise cancellation device 10D are replaced with a new ones, the active noise cancellation device 10D can reproduce the noise cancellation sound pattern and perform the active noise cancellation continuously and effectively.

Moreover, in the fourth exemplary embodiment, since the noise cancellation sound pattern d to f are produced by the noise cancellation sound pattern producing program so as to be associated with the internal chassis temperature, the produced noise cancellation sound patterns d to f can respond to the temperature change in the chassis.

The noise cancellation sound patterns d to f are produced for each noise cancellation control period. Since it can be considered that the internal chassis sound and the internal chassis temperature are constant in the noise cancellation control period, the noise cancellation sound patterns d to f can be produced easily.

Moreover, in the fourth exemplary embodiment, the active noise cancellation device 10D of the chassis with noise cancellation function 400 produces the noise cancellation sound patterns d to f based on each perceived noise which is received by each of the microphones 50d to 50f and which is perceived outside the chassis with noise cancellation function 400. The noise cancellation sound patterns d to f may be produced by the calculation circuit's performing weighting of each of the microphones 50d to 50f according to a desired level of the active noise cancellation, and performing the active noise cancellation.

The microphones 50d to 50f can be installed at a place about several meters away from the chassis with noise cancellation function 400 when the noise cancellation sound pattern is produced. In this case, terminals for connecting the microphones 50d to 50f with the chassis with noise cancellation function 400 are provided, and the active noise cancellation device 10D is connected with the microphones 50d to 50f via the connection terminals when producing the noise cancellation sound pattern. Further, when the microphones 50d to 50f are installed in places away from the chassis with noise cancellation function 400, by attaching a component such as a ferrite core to suppress emission of a radio wave from a connection wire, a bad influence is not given to a human body and more correct data can be obtained.

Moreover, in the fourth exemplary embodiment, since the chassis with noise cancellation function 400 includes the maintenance terminal 60, the chassis with noise cancellation function 400 can control the heater 52, the microphones 12d to 12f, the microphones 50d to 50f, the calculation circuit 14D and the like by using the maintenance terminal 60. It is possible that a user set a lower limit of the amplitude of the internal chassis sounds received by the microphones 12d to 12f, that is, an amplitude, a frequency range or the like of the internal chassis sound which start the active noise cancellation, with the maintenance terminal 60. Then, the above-mentioned control can be executed by the maintenance terminal 60 which reads a program from a medium storing the program for performing these controls.

In the chassis with active noise cancellation function 100, 200, 300 and 400 according to the above mentioned exemplary embodiments, the timer 19 which measures the noise cancellation control period is provided, and the noise cancellation sound pattern and the internal chassis sound are associated with each other for each the noise cancellation control period and stored in the memory circuits 11, 11B, 11C and 11D.

In the chassis with active noise cancellation function 100, 200, 300 and 400 according to the above mentioned exemplary embodiments, the first location is a place which is outside the chassis with noise cancellation function 100, 200, 300 and 400, and the second location is a place which is inside the chassis with noise cancellation function 100, 200, 300 and 400. Then, the speakers 13, 13C and 13D and the sound output unit 18 for outputting the noise cancellation sound are located in the first location.

Moreover, the noise cancellation parameter includes information about the amplitude and the frequency of the noise, and includes information about the phase which is 180 degrees different from the phase of the noise.

In the chassis with active noise cancellation function 100, 200, 300 and 400 according to the above mentioned exemplary embodiments, the temperature sensors 40 and 40a to 40f which measure the internal chassis temperature in the second location are provided. Then, the memory circuits 11, 11B, 11C and 11D store the noise cancellation parameter, the internal chassis sound and the internal chassis temperature that are associated with each other. The controllers 15, 15B, 15C and 15D select, from the memory circuits 11, 11B, 11C and 11D, the noise cancellation parameter corresponding to the surrounding sound received by using the speakers 13, 13C and 13D and the sound output unit 18 and the ambient temperatures measured by the temperature sensors 40 and 40a to 40f.

In the chassis with active noise cancellation function 100, 200, 300 and 400 according to the above mentioned exemplary embodiments, the maintenance terminal 60 is provided, which gives warning when the internal chassis sounds received by the microphones 12 and 12a to 12f and the sound receiving circuit 17 or the internal chassis temperatures measured by the temperature sensors 40 and 40a to 40f is out of the predetermined range.

In the active noise cancellation method according to the above mentioned exemplary embodiments includes separating the internal chassis sound received in the second location for each noise cancellation control period. Then, the noise cancellation sound data and the surrounding sound are mutually related and stored in the storing step, and the noise cancellation sound data is consecutively selected for the each predetermined period in the selecting step. Then, in the generating step, the noise cancellation sound is consecutively generated for each the predetermined period.

In the active noise cancellation method according to the above mentioned exemplary embodiments, a step is further included measuring the internal chassis temperature in the second location. Then, in the storing step, the noise cancellation sound data, the surrounding sound and the ambient temperature are mutually related and stored. In a selecting step, the noise cancellation parameter corresponding to the received internal chassis sound and the measured internal chassis temperature is selected.

The active noise cancellation method according to the above mentioned exemplary embodiments includes a step for second receiving the noise in the first location and the internal chassis sounds in the second location, a step for calculating the noise cancellation sound based on the noise in the first location. Then, in the storing step, the noise and the surrounding sound that are received by the second receiving are mutually related and stored in the memory circuits 11, 11B, 11C and 11D.

In a method for producing noise cancellation sound data according to the above mentioned exemplary embodiments, the method for producing noise cancellation sound data includes a step for measuring the internal chassis temperature in the second location. In the storing step, the noise cancellation parameter, the internal chassis sound and the internal chassis temperature are mutually related and stored.

Here, when the active noise cancellation device in the related technology 1 described in background art is used in order to perform the active noise cancellation of the noise which leaks from the inside to the outside of the chassis, following problems occur. That is, when performing active noise cancellation, the projector disclosed in the related technology 1 has to calculate a noise cancellation sound to be output. In the calculation for obtaining the noise cancellation sound, the projector initially measures a noise, and calculates frequency components in the noise. Moreover, the projector measures and analyzes a noise level for each frequency. Additionally, the projector performs phase control based on the analyzed result and obtains the noise cancellation sound. That is, the projector needs to carry out a complicated calculation in order to obtain the noise cancellation sound, when performing active noise cancellation.

In contrast, when the chassis with noise cancellation function and the noise cancellation method according to the present invention are applied in order to perform the active noise cancellation of the noise which leaks from the inside to the outside of the chassis, the following advantage is obtained. That is, the chassis with noise cancellation function stores noise cancellation sound data corresponding to the noise in the memory circuit in advance. When the active noise cancellation is performed, the noise cancellation sound data corresponding to the noise perceived by the sound receiving circuit is selected from the memory circuit, and the noise cancellation sound for the active noise cancellation is generated and output. Accordingly, the chassis with noise cancellation function and the noise cancellation method according to the present invention can accurately perform the active noise cancellation without carrying out a complicated calculation when performing the active noise cancellation.

Moreover, the method for producing noise cancellation sound data, the program for producing noise cancellation sound data and the medium according to the present invention produce the noise cancellation sound data from the noise perceived in the location where the active noise cancellation is performed, and the produced data is associated with the internal chassis sound received at that time and stored in the memory circuit. Accordingly, the noise cancellation sound data can be produced by which the active noise cancellation can be accurately performed in a desired location.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

Further, it is the inventor's intention to retain all equivalents of the claimed invention even if the claims are amended during prosecution.

What is claimed is:

1. A chassis with noise cancellation function which performs active noise cancellation in a first location for cancelling a noise generated in said chassis, comprising:
a sound receiving circuit receiving a surrounding sound in a second location;
a memory circuit storing noise cancellation sound data and said surrounding sound that are associated with each other;
a controller selecting said noise cancellation sound data corresponding to said surrounding sound received by said sound receiving circuit from said memory circuit and generating a noise cancellation signal based on said selected noise cancellation sound data; and
a sound output unit outputting a noise cancellation sound in said first location based on said noise cancellation signal to perform said active noise cancellation.

2. The chassis with noise cancellation function according to claim 1, further comprising:
a timer circuit measuring a predetermined time period;
wherein said noise cancellation sound data and said surrounding sound are associated with each other for each said predetermined time period, and stored in said memory circuit.

3. The chassis with noise cancellation function according to claim 1, wherein
said first location is a place which is outside said chassis with noise cancellation function;
said second location is a place which is inside said chassis with noise cancellation function; and
wherein said sound output unit is located in said first location.

4. The chassis with noise cancellation function according to claim 3, wherein
said noise cancellation sound data includes information about an amplitude and a frequency of said noise, and includes information about a phase which is 180 degrees different from a phase of said noise.

5. The chassis with noise cancellation function according to claim 1, further comprising:
a temperature sensor measuring an ambient temperature in said second location and;
wherein said memory circuit stores said noise cancellation sound data, said surrounding sound and said ambient temperature that are associated with each other, and
wherein said controller selects said noise cancellation sound data corresponding to said surrounding sound received by said sound receiving circuit and said ambient temperature measured by said temperature sensor from said memory circuit.

6. The chassis with noise cancellation function according to claim 5, further comprising:
a warning device giving warning when said surrounding sound received by said sound receiving circuit or said ambient temperature measured by said temperature sensor is out of a predetermined range.

7. A noise cancellation method for performing active noise cancellation in a first location of chassis with noise cancellation function, comprising steps of:
storing noise cancellation sound data and a surrounding sound that are associated with each other in a memory circuit;
receiving said surrounding sound in a second location;
selecting said noise cancellation sound data corresponding to said received surrounding sound from said memory circuit; and
generating a noise cancellation sound based on said selected noise cancellation sound data to perform said active noise cancellation for a noise generated in said chassis in said first location.

8. The noise cancellation method according to claim 7, further comprising step of:
separating said received surrounding sound for each said predetermined time period, wherein
in said storing step, said noise cancellation sound data and said surrounding sound are mutually related and stored,
in said selecting step, said noise cancellation sound data is consecutively selected for said each predetermined period, and
in said generating step, said noise cancellation sound is consecutively generated for each said predetermined period.

9. The noise cancellation method according to claim 7, further comprising:
measuring an ambient temperature in said second location, wherein
in said storing step, said noise cancellation sound data, said surrounding sound and said ambient temperature are mutually related and stored, and wherein
in said selecting step, said noise cancellation sound data corresponding to said received surrounding sound and said measured ambient temperature is selected.

10. The noise cancellation method according to claim 7, further comprising:
second receiving said noise in said first location and said surrounding sound in said second location;
calculating said noise cancellation sound based on said noise being received in said first location, wherein
in said storing step, said noise and said surrounding sound that are received by said second receiving are mutually related and stored.

11. A method for producing noise cancellation sound data which specifies a noise cancellation sound for performing active noise cancellation in a first location, the method comprising steps of:
receiving a noise in said first location and a surrounding sound in a second location;
calculating an amplitude, a frequency and a phase of said noise;
generating said noise cancellation sound data including said calculated amplitude, said calculated frequency and a phase which is 180 degrees different from said calculated phase; and
storing said noise cancellation sound data and said surrounding sound that are associated with each other in a memory circuit.

12. The method for producing noise cancellation sound data according to claim 11, further comprising:
measuring an ambient temperature in said second location, wherein
in said storing step, said noise cancellation sound data, said surrounding sound and said ambient temperature are mutually related and stored.

13. A computer executable program for producing noise cancellation sound data, comprising:
a receiving routine for receiving a noise in said first location and a surrounding sound in a second location;
a calculating routine for calculating an amplitude, a frequency and a phase of said noise;
a generating routine for generating said noise cancellation sound data including said calculated amplitude and frequency, and a phase which is 180 degrees different from said calculated phase; and
a storing routine for storing said noise cancellation sound data and said surrounding sound that are associated with each other in a memory circuit.

14. A computer readable medium storing a program for producing noise cancellation sound data, said program comprising:
a receiving routine for receiving a noise in said first location and a surrounding sound in a second location;
a calculating routine for calculating an amplitude, a frequency and a phase of said noise;
a generating routine for generating said noise cancellation sound data including said calculated amplitude and frequency, and a phase which is 180 degrees different from said calculated phase; and
a storing routine for storing said noise cancellation sound data and said surrounding sound that are associated with each other in a memory circuit.

15. A chassis with noise cancellation function which performs active noise cancellation in a first location for cancelling a noise generated in said chassis, comprising:
sound receiving means for receiving a surrounding sound in a second location;
storing means for storing noise cancellation sound data and said surrounding sound that are associated with each other;
means for selecting said noise cancellation sound data corresponding to said surrounding sound received by said sound receiving means from said storing means and generating a noise cancellation signal based on said selected noise cancellation sound data; and
outputting means for outputting a noise cancellation sound in said first location based on said noise cancellation signal to perform said active noise cancellation.
